(19) United States
(12) Patent Application Publication
(10) Pub. No.: US 2004/0025061 A1
(43) Pub. Date: Feb. 5, 2004

(54) Method and system for power reduction

(76) Inventor: Richard H. Lawrence, Hudson, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/045,324

(22) Filed: Oct. 25, 2001

(51) Int. Cl. G06F 1/26

(52) U.S. Cl. 713/300

(57) ABSTRACT

A system and method to adjust a voltage level to a processor based at least in part on the system's temperature and/or clock frequency.

[symbol] This disclosure generally relates to power reduction.

2. Background Information

The demand for more powerful computers and communication products has resulted in faster processors that often consume increasing amounts of power. However, design engineers struggle with reducing power consumption, for example, to prolong battery life, particularly in mobile and communication systems.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a sample table of supply voltage with respect to the temperature and clock frequency of a processor.

FIG. 2 is a schematic diagram of a computing system in accordance with one embodiment.

FIG. 3 is a schematic diagram of a computing system in accordance with one embodiment.

FIG. 4 is a schematic diagram of a computing system in accordance with one embodiment.

FIG. 5 is a schematic diagram of a network in accordance with one embodiment.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

In general, designers desire to reduce power consumption. Typically, supply voltage for the processor is based at least in part on a worst-case scenario for its operating temperature and clock frequency. As the processor operates at a higher temperature, the performance of the transistors for the processor may degrade and become slower. However, a higher supply voltage may compensate for the decreased performance of the transistors and allow them to operate faster.

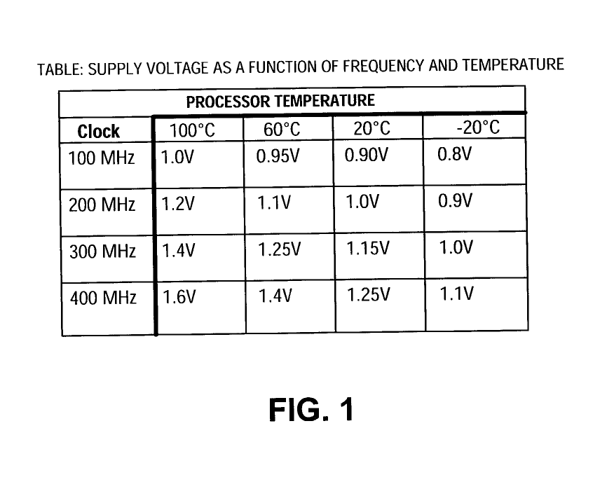

For example, FIG. 1 depicts a table illustrating an example of supply voltages for a processor with respect to its clock frequency and temperature. The processor is designed to operate in a temperature range, such as between −20C and approximately 100C and in a clock frequency range between approximately 100 Mhz and approximately 400 Mhz. Again, the supply voltage for reliable operation is based on a worst-case scenario. In this example, the supply voltage for reliable operation in the specified temperature and clock frequency range is 1.6 volts because the worst-case scenario is 400 Mhz and 100C.

Utilizing a worst-case scenario for selecting a supply voltage, however, limits the choice of supply voltages because the scenario only considers a single or limited number of data points, such as in FIG. 1. A negative consequence of such an approach is higher power consumption. For example, higher power consumption may adversely affect battery life in mobile systems, such as, cell phones, personal digital assistants (PDAs), laptops, and other systems. The use of supply voltage based on the worst-case scenario may, therefore, reduce the battery life of mobile devices and limit design flexibility.

An area of current technological development relates to achieving longer battery life for communication products and computer or computing systems by reducing power consumption. As previously described, a selected low supply voltage is based on a worst-case scenario of operation within the intended operating range of a processor with respect to the temperature and clock frequency of the processor. However, such an approach may be inflexible or inefficient. For example, a processor may operate at a lower supply voltage for lower temperatures and lower clock frequencies. Thus, implementing a more efficient method of adjusting the supply voltage at different temperatures and clock frequencies is desirable.

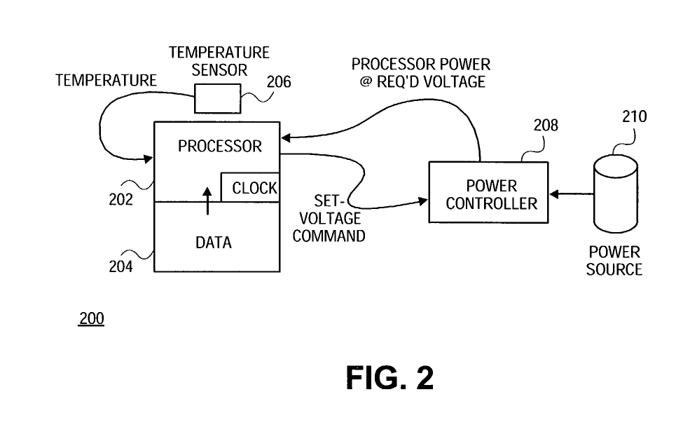

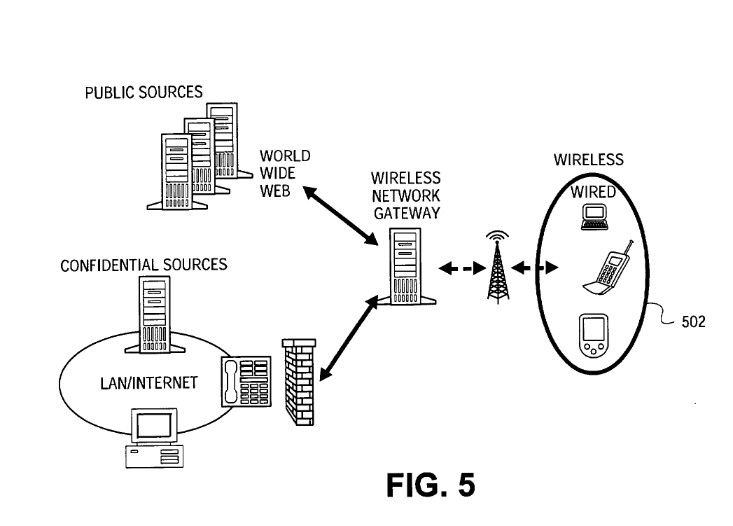

FIG. 2 is a computing system 200 in accordance with one embodiment. System embodiment 200 includes, but is not limited to, a processor 202, a temperature sensor 206, a power controller 208, and a power source 210. Likewise, the processor may include data, such as 204, in a memory. The system may comprise, for example, a personal computer system, a personal digital assistant (PDA), a cellular phone, or an Internet communication device, such as, a web tablet. Of course, these are merely examples and the claimed subject matter is not limited in scope to these examples. The claimed subject matter may also include wireless or wired products, which is discussed further in connection with FIG. 5.

Although the scope of the claimed subject matter is not limited in this respect, it is noted that some embodiments may further include subject matter from the following concurrently filed applications: U.S. application Ser. No. ______, and titled “A System and Method for Managing Data in Memory for Reducing Power Consumption”, by Richard H. Lawrence, attorney docket number P11725; and a U.S. patent application Ser. No. ______, titled “A System and Method for Reducing Power Consumption based at least in part on Temperature and Frequency of a Memory”, by Richard H. Lawrence, attorney docket number P11724.

The system 200 is capable of providing an acceptably low supply voltage to the processor based at least in part on the operating temperature and clock frequency of the processor. In one aspect, the claimed subject matter is distinguishable from the prior art in that the supply voltage may be based at least in part on the operating temperature or the clock frequency, or both, rather than the typical worst-case scenario or prior art throttling applications that reduce processor's frequency with respect to the sensed temperature. Also, the claimed support matter may adjust the supply voltage based on additional factors, such as the type of application (military or consumer), the number of additional processors, respective temperatures or clock frequencies, etc. For example, the system may have a plurality of processors and the acceptably low supply voltage may be individually calculated for each processor or some of the processors, or calculated based on the average of at least a few of the associated temperatures and clock frequencies.

In this embodiment, system 200 receives a set of data 204, which at least in part contains acceptably low supply voltages calculated for different temperatures and different clock frequencies. The set of data may be calculated, for example, by testing a plurality of systems to determine the acceptably low supply voltage for different temperatures and different clock frequencies, although the claimed subject matter is not limited in this respect. In one embodiment the set of data may be loaded into flash memory coupled to the processor.

In one embodiment, a plurality of processors is tested at different temperatures and clock frequencies, and a supply voltage is calculated to ensure the processor operates correctly at selected temperatures and clock frequencies. Thus, a predetermined quantity of processors or systems may be pre-characterized to determine the set of data for specifying an acceptably low supply voltage based at least in part on the temperature and clock frequency. For example, the set of data may be similar to the previously discussed table in FIG. 1. Of course, the claimed subject matter is not limited in this respect. The set of data could have more data points than illustrated in FIG. 1. For example, the temperature range could be from −40° C. to 120° C. or from 0° C. to 60° C. Similarly, the supply voltage may be calculated for increments in temperature of 5° C., rather than the 40° C. increments as illustrated in FIG. 1. The supply voltage may be calculated for larger or smaller clock frequencies at different increments. Likewise, the set of data could be calculated to include other factors, as discussed earlier, such as calculating an average temperature of a plurality of processors to produce a multi-dimensional graph, rather than the two dimensional graph in FIG. 1. Thus, any one of a number of techniques may be employed to provide the desired data.

After the set of data has been determined, the system may load the data into memory. In one embodiment, the memory comprises a flash memory. However, the claimed subject matter is not limited in scope to a particular storage mechanism or device. For example, the data may be loaded into volatile memory, such as dynamic random access memory (DRAM), or static random access memory (SRAM). Also, the set of data may not reside in local memory. For example, the set of data may be loaded into external test equipment for comparison and analysis. Alternatively, the data may be loaded into the power controller 208. Likewise, the system may receive the set of data from a network via a wired or wireless connection.

System 200 therefore, may monitor the temperature with temperature sensor 206. In one embodiment, the temperature sensor forwards the processor's sensed temperature to the processor. The temperature sensor may be integrated into the processor. For example, the sensor may be incorporated into the processor's design and manufactured as part of the processor, although the subject matter is not limited in scope in this respect. Alternatively, the temperature sensor may be physically attached to the processor's package. Another embodiment may include a plurality of temperature sensors attached internally or externally to the processor with an average temperature calculated using measurements from the plurality of temperature sensors. In yet another example, the temperature sensor may be located on or near the system board, such as within several centimeters, and the temperature may be extrapolated from the sensors' readings.

The processor upon or after receiving one or more temperature measurements, such as described above, for example, may determine an acceptably low supply voltage. In one embodiment, the acceptably low supply voltage is determined by testing a plurality of systems, while decreasing the supply voltage. Eventually, as the supply voltage decreases to a certain threshold, the systems will fail the testing because of insufficient supply voltage. Subsequently, the supply voltage is slowly increased until the plurality of systems function properly and pass the testing. Thus, the acceptably low supply voltage is calculated based on the preceding example. Of course, the claimed subject matter is not limited in this respect.

As discussed earlier, in one embodiment the set of data may be similar to the table in FIG. 1. For example, from two data points and the set of data, the processor or power controller may adjust the present supply voltage to the acceptably low supply voltage obtained from the set of data. For example, assume power source 210 is presently supplying 1.5 volts to the system. If temperature sensor senses, for example, a 60° C. temperature and the current processor clock frequency is measured to be 400 Mhz, the processor or power controller may query the set of data based at least in part on the 60° C. sensed temperature and the 400 Mhz clock frequency. If the set of data is similar to FIG. 1, an acceptably low supply voltage for 60° C. and 400 Mhz is 1.4 volts. Then, since the system is currently using 1.5 volts, the supply voltage is lowered to 1.4 volts to reduce power consumption in this particular embodiment. Such an embodiment, therefore, allows for flexible and efficient setting of power supply voltage at various temperatures and clock frequencies. In contrast, the worst-case scenario approach allows for only one supply voltage regardless of different temperatures and different clock frequencies.

One aspect of the claimed subject matter may include the processor or power controller issuing a set voltage command to the power source to set the supply voltage to the acceptably low supply voltage.

In one embodiment, the power controller may be integrated with the power supply and is internal to the system. Of course, the claimed subject matter is not limited in this respect. For example, the power controller may be coupled to an external power source. Alternatively, the power controller and the power source may be external to the system.

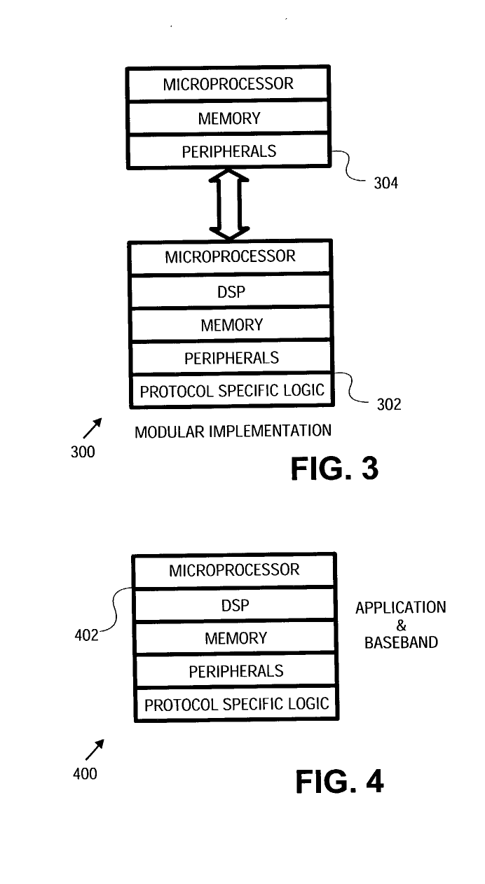

In one embodiment, the claimed subject matter is incorporated into a communication or wireless device and/or implemented with Intel® XScale™ micro architecture and Intel™ Personal Internet Client Architecture (Intel® PCA) and is discussed further in FIGS. 3, 4, and 5.

FIG. 3 is a schematic diagram of a computing system in accordance with one embodiment. The schematic represents a flexible design implementation for communication products. In one embodiment for a single processor, logic blocks 302 and 304 represents a modular process wherein the communication processor and application processor may be logically separated. Thus, only one communication processor may be employed for a wireless protocol, and one application processor for a set of applications.

The communication processor 302 is designed for a particular wireless protocol. For example, the protocol specific logic is designed for a plurality of existing wireless standards such as personal digital cellular (PCS), personal digital cellular (PDC), global system for mobile communications (GSM), time division multiple access (TDMA), and code division multiple access (CDMA). The protocol specific logic can support a variety of standards such as IS-136, IS-95, IS-54, GSM1800 and GSM1900.

Communication processor 302 comprises, but is not limited to, a digital signal processor (DSP), a microprocessor, and memory, and peripherals. The application processor 304, comprises, but is not limited to, a microprocessor, memory and peripherals. The application processor may be general purpose and re-programmable. Also, it is capable of executing native binaries in the system, or from another communication product, or from a network. Thus, the application processor is coupled to the communication processor and is logically separated. Therefore, each processor can be developed in parallel rather than the typical serial process.

In one embodiment, the communication processor and application processor may be manufactured on a silicon wafer. However, the processors may operate independently and may have different operating systems. In another embodiment, the communication processor and application processor may be coupled to a common memory controller, which in turn may be coupled to a common memory. Alternatively, each processor may integrate their respective memories. For example, processors may have memory residing on the processor die, rather than having a separate memory. Examples of various memories that may be integrated into each processor are flash memory, static random access memory, and dynamic random access memory.

Although the subject matter is not limited in scope in this respect, Intel® XScale™ micro architecture and Intel® Personal Internet Client Architecture (Intel® PCA) may support a modular implementation as illustrated in FIG. 3. Also, the architectures may support a variety of features, such as a browser to access Internet content and applications, a user interface for allowing interaction with content and applications that include speech, graphics, video, and audio. The architectures may have a file system to manage and protect access to applications, communications, and network code. The architectures may allow for radio interface to transmit and receive from a wireless carrier or service bearer. Further, the architectures may allow for system management for the application processor's operating system kernel, user applications, and the communications processor's real time operating system functions, and content or data payload. Of course, the claimed subject matter is not limited in this respect.

FIG. 4 is a schematic diagram of a computing system in accordance with one embodiment. The block diagram 402 illustrates an integrated implementation of an application and communication processor. In one embodiment, block diagram 402 is utilized in a system with multiple processors. The block diagram comprises, but is not limited to, a digital signal processor (DSP), a microprocessor, and memory, peripherals, a microprocessor, memory, and peripherals. In one aspect, FIG. 4 differs from FIG. 3 in that a single integrated logic processor 402 supports both the application and communication functions. In contrast, FIG. 3 is a modular design and illustrates two processors to individually support either the communication or application functions.

Although the subject matter is not limited in scope in this respect, Intel® XScale™ micro architecture and Intel® Personal Internet Client Architecture (Intel® PCA) may support an integrated implementation as illustrated in FIG. 4. Also, the architectures may support a variety of features, such as a browser to access Internet content and applications, a user interface for allowing interaction with content and applications that include speech, graphics, video and audio. The architectures may have a file system to manage and protect access to applications, communications, and network code. The architectures may allow for radio interface to transmit and receive from a wireless carrier or service bearer. Further, the architectures may allow for system management for the application processor's operating system kernel, user applications, and the communications processor's real time operating system functions, and content or data payload. Of course, the claimed subject matter is not limited in this respect.

FIG. 5 is a schematic diagram of a network in accordance with one embodiment. In one embodiment, the previously described system for reducing power consumption in FIG. 2 and the modular implementation for communication products and architectures described in FIGS. 3 and 4 may be implemented in various communication products as depicted in FIG. 5. For example, the communication products may include, but is not limited to, Internet tablets, cellular phones, personal digital assistants, pagers, and personal organizers. Also, the communication products may receive information via a wired or wireless connection.

Of course, the claimed subject matter is not limited in this respect. For example, one skilled in the art will appreciate the claimed subject matter may also include systems that provide low power consumption and use batteries as a power source. Alternatively, the claimed subject matter may also include a system or boards that employ thermal dissipation. One example includes a rack-mount of servers with multiple boards plugged into rack-mounted enclosures. The boards are closely spaced and may consume large amounts of power. Therefore, the claimed subject matter may improve the thermal dissipation by reducing the power consumption.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1 A system comprising:
a processor with an adjustable supply voltage;
at least one temperature sensor, coupled to the processor to sense a temperature of the processor;
the system to adjust the processor's supply voltage to an acceptably low supply voltage based at least in part on the processor's sensed temperature and a sensed clock frequency of the processor; and
a flash memory to store a plurality of the acceptably low supply voltages for the processor based at least in part on the processors sensed clock frequency and the processor's sensed temperature

2. The system of claim 1 wherein the system is coupled to a power source integrated with a power controller.

3. The system of claim 1 wherein the temperature sensor is integrated with the processor.

4. The system of claim 1 wherein the temperature sensor is attached to a ceramic package of the processor.

5. The system of claim 1 wherein the temperature sensor is located within zero to seven centimeters of the processor.

6. The system of claim 1 wherein the system comprises at least one of a personal digital assistant, a cell phone, an Internet tablet, or a personal computer.

7. An article comprising:
a storage medium having stored thereon instructions, that, when executed by a computing platform, result in execution of adjusting a supply voltage to a system's processor by:
sensing the system processor's temperature;
storing a plurality of acceptably low supply voltages based at least in part on the processor's sensed temperature and the processor's sensed clock frequency; and
generating a command to adjust the system's supply voltage to approximately the acceptably low supply voltage.

8. The article of claim 7, wherein said storing the plurality of acceptably low supply voltages comprises writing the acceptably low supply voltage to a flash memory.

9. The article of claim 7, wherein said generating a command comprises transmitting the command from the system processor to a power source.

10. The article of claim 7, wherein said generating a command comprises transmitting the command from a power controller to a power source.

11. The article of claim 7, wherein the system comprises at least one of a personal digital assistant, a cell phone, an Internet tablet, or a personal computer.

12. A method of adjusting a voltage level to a processor comprising:
sensing a temperature and a clock frequency of the processor;
comparing the processor's sensed temperature and the processor's clock frequency to a table of data of an acceptably low voltage level for a plurality of processor's sensed temperatures and processor's sensed clock frequencies; and
adjusting the voltage level of the processor to the acceptably low voltage level based at least in part on the processor's sensed temperature and the processor's sensed clock frequenc

13. The method of claim 12 further comprising storing the table of data in a flash memory.

14. The method of claim 12 wherein adjusting the voltage level comprises generating a set voltage command.

15. The method of claim 14 wherein generating the set voltage command comprises transmitting the set voltage command to a power source.
